(19) United States
(12) Patent Application Publication
(10) Pub. No.: US 2026/0046961 A1
(43) Pub. Date: Feb. 12, 2026

(54) METHODS, ARCHITECTURES, APPARATUSES AND SYSTEMS WITH STEERING MODE ENHANCEMENTS FOR DUALSTEER CAPABLE DEVICES

(71) Applicant: InterDigital Patent Holdings, Inc., Wilmington, DE (US)

(72) Inventors: Rocco Di Girolamo, Laval (CA); Xavier De Foy, Kirkland (CA); Anuj Sethi, Ottawa (CA); Taimoor Abbas, Sainte-Julie (CA); Guanzhou Wang, Brossard (CA); Magurawalage Chathura Madhusanka Sarathchandra, London (GB)

(21) Appl. No.: 18/798,736

(22) Filed: Aug. 8, 2024

(51) Int. Cl. H04W 76/15; H04W 8/22; H04W 60/04

(52) U.S. Cl. CPC H04W 76/15; H04W 8/22; H04W 60/04

(57) ABSTRACT

Procedures, methods, architectures, apparatuses, systems, devices, and computer program products for a WTRU with DualSteer capability that includes a first user UE and a second UE. The method includes registering each of the first UE and second UE with wireless networks based on first evaluation criteria and on second evaluation criteria, respectively, and transmitting a PDU session establishment request to the wireless networks. The method further includes receiving, from the wireless networks, information indicative of an acceptance of the PDU session establishment request, a steering mode configuration generated based on the first evaluation criteria and the second evaluation criteria, and steering mode assistance information, determining how to steer, switch, split, or duplicate over each PDU session based on: a respective trigger, the respective steering mode assistance information, and respective steering mode configuration, and communicating over the PDU sessions based on the determination.

### BACKGROUND

The present disclosure is generally directed to the fields of communications, software and encoding, including, for example, to methods, architectures, apparatuses, systems related to steering, switching, splitting, or duplicating traffic for DualSteer capable devices.

### SUMMARY

In certain representative embodiments, a method or procedure, and related apparatuses for a WTRU with DualSteer capability with a first UE and a second UE is provided. The methods and procedures disclosed herein includes registering the first UE with a first set of wireless networks based on first evaluation criteria and registering second UE with a second set of wireless networks based on second evaluation criteria. The WTRU then transmits, to the wireless network, a respective protocol data unit (PDU) session establishment request to each of the first set of wireless networks and the second set of wireless networks and receives, from the first set of wireless networks and the second set of wireless networks, respective information indicative of an acceptance of the PDU session establishment request, a steering mode configuration generated based on the first evaluation criteria and the second evaluation criteria, and steering mode assistance information. The WTRU is also configured to determine how to steer, switch, split, or duplicate traffic over each PDU session based on: a respective trigger (e.g., triggering event), the respective steering mode assistance information, and the respective steering mode configuration and to communicate over the respective PDU sessions based on the determination on how to steer, switch, split, or duplicate traffic over each PDU session.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGs.) and the detailed description are not to be considered limiting, and other equally effective examples are possible and likely. Furthermore, like reference numerals (“ref.”) in the FIGs. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is a block diagram illustrating an example of a WTRU system that may be used within the communications system illustrated in FIG. 1A;

FIG. 3 is a block diagram illustrating another example of a WTRU system that may be used within the communications system illustrated in FIG. 1A;

FIG. 4 is a block diagram illustrating example SDFs transmitted over a network with a data radio bearer (DRB), where the network may be implemented within the communications system illustrated in FIG. 1A;

FIG. 5 is a procedure for managing traffic over a PDU session that may be established with a wireless network implemented on the communications system illustrated in FIG. 1A; and

FIG. 6 is a flowchart of an illustrative process for managing traffic over a PDU session with a wireless network, which may be implemented using the communications system illustrated in FIG. 1A.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

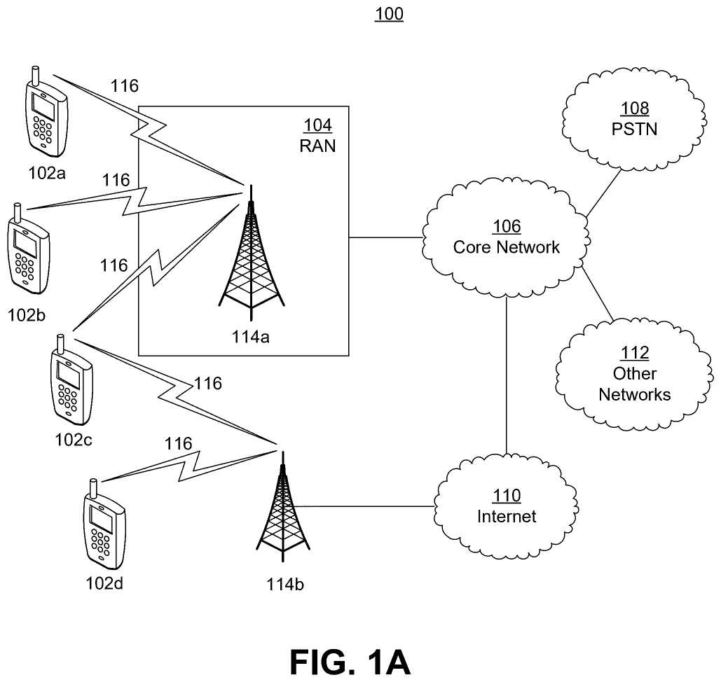

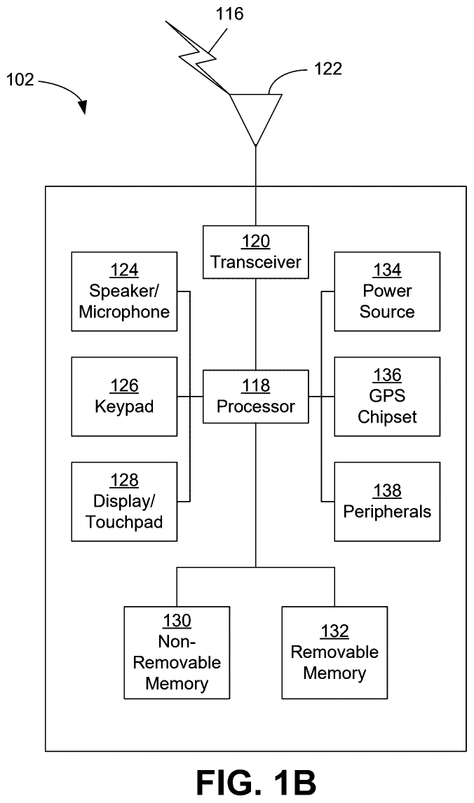

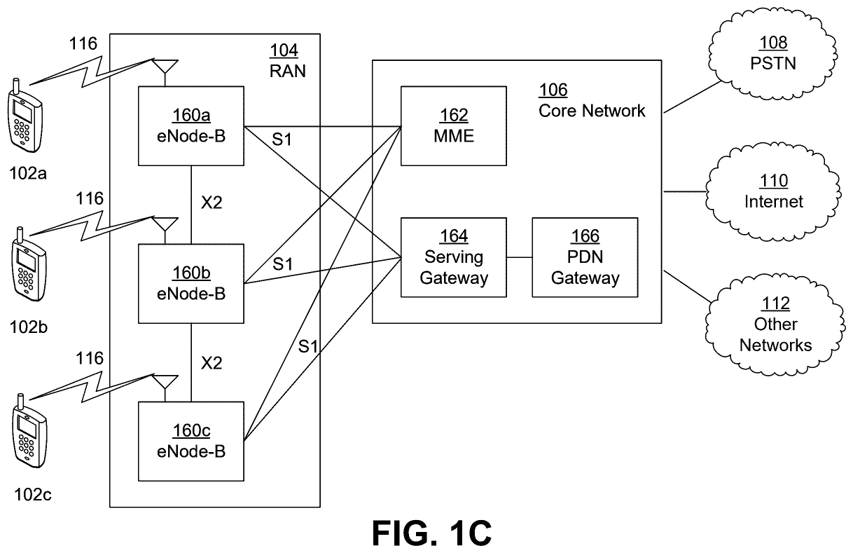

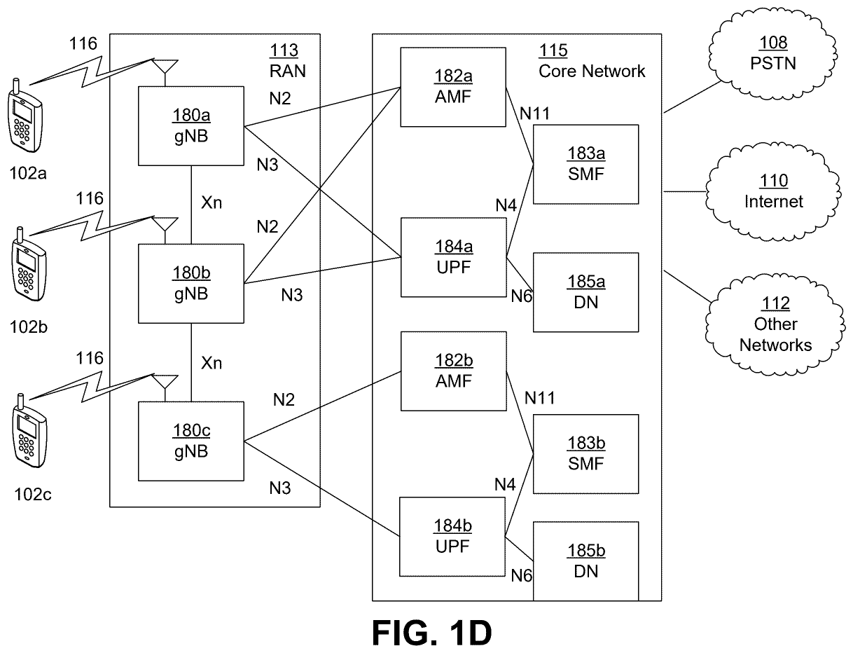

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a UE, a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an evolved Node-B (eNB), a Home Node-B (HNB), a Home eNode-B (HeNB), a next generation Node-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation (CA) technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of Non-Access Stratum (NAS) signaling, mobility management (MM), and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Overview

### Splitting Traffic Across 3GPP Access Leg and Non-3GPP Access Leg: Access Traffic Steering, Switching, Splitting (ATSSS) in 3GPP

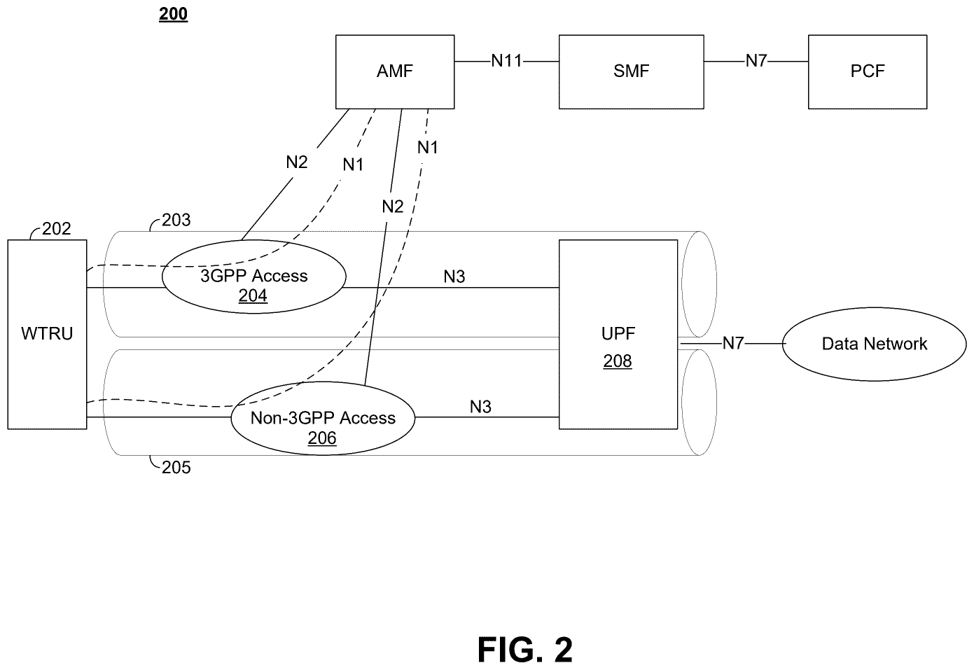

As shown in FIG. 2, a WTRU (e.g., WTRU 202), which is communicatively coupled to a network, is capable of using both a 3GPP access 204 and a non-3GPP access 206. This capability of the WTRU 202 may provide flexibility to the network operators of the wireless network in determining which access (e.g., 3GPP access 204 or non-3GPP access 206) to use for a service data flow (SDF). In some implementations, WTRU 202 may be required to use both accesses (e.g., 3GPP access 204 or non-3GPP access 206) to establish independent single-access (SA) Protocol Data Unit (PDU) sessions (e.g., an SA 3GPP PDU session 203 and an SA non-3GPP PDU session 205) over each of the accesses (e.g., 3GPP access 204 or non-3GPP access 206). Although FIG. 2 illustrates a single UPF 208, the network architecture 200 may include a first UPF that is used for the 3GPP access 204 and a second UPF that is used for the non-3GPP access 206.

However, a network architecture, such as network architecture 200, may not take full advantage of this flexibility. As a result, a network architecture may be implemented with a multi-access (MA) PDU session, allowing uplink (UL) and downlink (DL) traffic of a SDF to be more easily steered, switched, or split between accesses (e.g., 3GPP access and non-3GPP access). An MA PDU session may be defined as a PDU session whose traffic may be sent over a 3GPP access, or over a non-3GPP access, or over both accesses (e.g., 3GPP access and non-3GPP access).

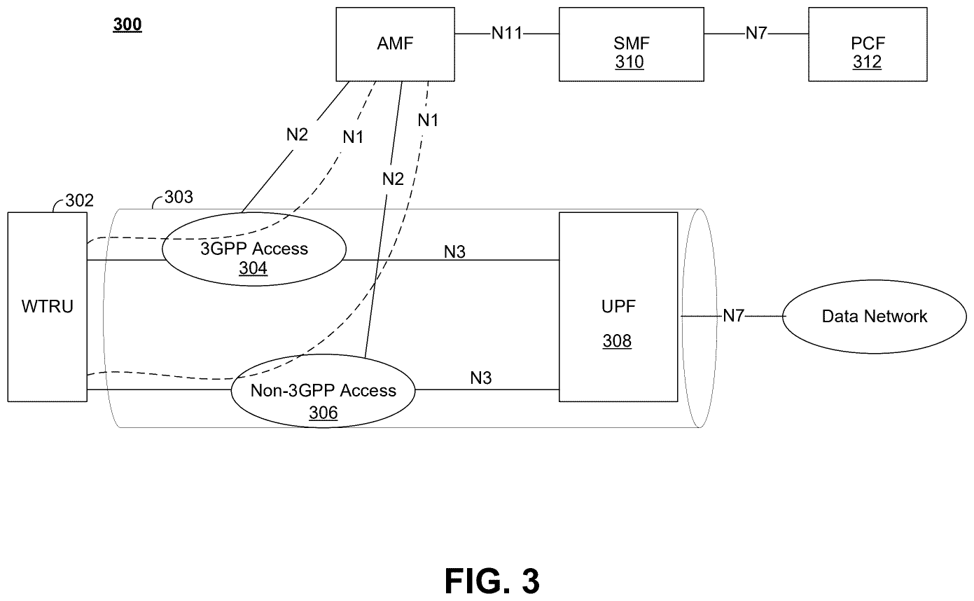

FIG. 3 shows network architecture 300 including WTRU 302 which uses MA PDU session 303 for UL and DL traffic of a SDF to be steered, switched or split between accesses (e.g., 3GPP access 304 and non-3GPP access 306) using ATSSS. The present disclosure provides a network architecture (e.g., network architecture 300) for ATSSS which may be performed by one of the WTRU 302 and the UPF 308 of the MA PDU session 303. The network architecture (e.g., network architecture 300) provided may enable certain steering functionality, such as (1) traffic steering of a new data flow, where an access network (e.g., 3GPP access 304 or non-3GPP access 306) may be selected, by the WTRU 302 and/or UPF 308, for the new data flow and transfers the traffic of this data flow over the selected access network (e.g., 3GPP access 304 or non-3GPP access 306), (2) traffic switching, where an ongoing data flow can be moved, by the WTRU 302 and/or UPF 308, from one access network (e.g., 3GPP access 304) to another access network (e.g., non-3GPP access 306) in a way that maintains the continuity of the data flow, and (3) traffic splitting, where the traffic of a data flow can be split, by the WTRU 302 and/or UPF 308, across multiple access networks (e.g., 3GPP access 304 and non-3GPP access 306). In some embodiments, when traffic splitting is applied to a data flow, some PDUs of the data flow are transmitted via one access and some other PDUs of the same data flow are transmitted via another access. Each steering functionality may be applied between a 3GPP access network (e.g., 3GPP access 304) and a non-3GPP access network (e.g., non-3GPP access 306).

The steering functionality, which may be implemented in one or more of the ATSSS-capable WTRU 302 and in the UPF 308, may steer, switch, and/or split traffic of the MA PDU session 303 (e.g., PDUs of a SDF) across multiple accesses (e.g., 3GPP access 304 and non-3GPP access 306). Two steering functionalities are disclosed herein, including a high-layer steering functionalities, which operates above the IP layer, e.g., the Multipath Transmission Control Protocol (MPTCP) steering functionality that may apply to Transmission Control Protocol (TCP) traffic, and a low-layer steering functionality, which may operate below the IP layer, e.g., the ATSSS Low-Layer functionality (ATSSS-LL) which may apply to Ethernet and IP traffic (e.g., TCP and UDP traffic). Each of these steering functionalities may be implemented in the WTRU 302 and/or the UPF 308, each of which are endpoints of the PDU session (e.g., MA PDU session 303).

A steering mode may be used to determine how the traffic of a corresponding service data flow should be distributed across accesses (e.g., 3GPP access 304 and non-3GPP access 306).

An active-standby steering mode may configure one or both of the WTRU 302 and UPF 308 to steer traffic of a respective SDF on one access (e.g., an active access) when the active access is available, and may switch the traffic to the other access (e.g., a standby access) when the active access becomes unavailable.

A smallest delay steering mode may configure one or both of the WTRU 302 and UPF 308 to steer traffic of a respective SDF to an access that is determined to have the smallest Round-Trip Time (RTT). The RTT may be defined as a duration of time for a network request to go from a starting point to a destination and back again to the starting point. One or both of the WTRU 302 and UPF 308 may be configured to measure an RTT for each access (e.g., 3GPP access 304 and non-3GPP access 306) in order to determine which access has the lowest RTT. In some embodiments, the smallest delay steering mode may (e.g., only) be used for a non-guaranteed bit rate (non-GBR) SDF.

A load balancing steering mode may configure one or both of the WTRU 302 and the UPF 308 to split traffic of a respective SDF across both accesses (e.g., 3GPP access 304 and non-3GPP access 306) according to a configurable load balancing percentage. For example, the configurable load balancing percentage may be set to 30%, and one or both of the WTRU 302 and UPF 308 may be configured to use the 3GPP access 304 for 30% of the PDUs of the SDF, and the non-3GPP access 306 for 70% of the PDUs of the SDF. In some embodiments, the load balancing steering mode may (e.g., only) be used for a non-GBR SDF.

A priority based steering mode may configure one or both of the WTRU 302 and the UPF 310 to steer (e.g., all) traffic of a respective SDF which matches a policy and charging control (PCC) rule to a high priority access, until the high priority access is determined to be congested. Once the high-priority access is determined to be congested, one or both of the WTRU 302 and UPF 308 may be configured to steer traffic of the SDF to the low priority access, i.e., the traffic of the SDF may be split over the two accesses. In some embodiments, the priority based steering mode may (e.g., only) be used for a non-GBR SDF.

In some implementations, a steering mode indicator (e.g., an autonomous load-balance indicator or a WTRU-assistance indicator) may be used to indicate that one or both of the WTRU 302 or UPF 308 may change default parameters provided by the steering mode (e.g., the load balancing steering mode) and may adjust the traffic steering. In some embodiments when using a load balancing steering mode, an autonomous load-balance indicator may be provided by the network, and the WTRU 302 (e.g., or UPF 308) may be configured to ignore the load balancing percentage and autonomously determine the load balancing percentage for traffic splitting that maximizes an aggregate bandwidth in the UL direction. In some embodiments, a WTRU-assistance indicator may be provided by the network to indicate that (a) the WTRU 302 may determine how to distribute the UL traffic of the corresponding SDF based on an internal state of the WTRU (e.g., when the WTRU is in a particular internal state, such as a lower battery level state), and (b) the WTRU 302 may inform the UPF 308 how the WTRU 302 has determined to distribute the UL traffic of the corresponding SDF. In some embodiments, even when the WTRU-assistance indicator is provided, the WTRU 302 may distribute the UL traffic as indicated by the network.

In addition, for the load balancing steering mode, a first threshold value may be used, the first threshold value being either a first RTT threshold value or a first Packet Loss Rate (PLR) threshold value. The first threshold values may be applicable to both accesses (e.g., 3GPP access 304 and non-3GPP access 306) and may be applied by one or both of WTRU 302 and UPF 308. When at least one measured parameter (e.g., RTT or PLR) on one access (e.g., 3GPP access 304 or non-3GPP access 306) exceeds one or both of the provided first threshold values (e.g., first RTT threshold value or first PLR threshold value), the WTRU 302 and UPF 308 may stop sending traffic on this access, or may continue sending traffic on this access but with reduced traffic by a predetermined amount and may send the amount of reduced traffic to the other access. In some implementations, when all measured parameters (e.g., RTT and PLR) for both accesses (e.g., 3GPP access 304 and non-3GPP access 306) do not exceed the provided first threshold values (e.g., first RTT threshold value and first PLR threshold value), the WTRU 302 and UPF 308 may distribute traffic between both accesses (e.g., 3GPP access 304 and non-3GPP access 306) according to fixed split percentages.

Similarly, for the priority-based steering mode, a second threshold value may be used, the second threshold value being either a second RTT threshold value or a second PLR threshold value. The second threshold values may be applicable to both accesses (e.g., 3GPP access 304 and non-3GPP access 306) and may be applied by one or both of the WTRU 302 and UPF 308. In some implementations, either of these second threshold values (e.g., second RTT threshold value or second PLR threshold value) may be considered by WTRU 302 and UPF 308 to determine when an access (e.g., 3GPP access 304 or non-3GPP access 306) becomes congested. For example, when a measured parameter (e.g., RTT or PLR) on one access exceeds a provided second threshold value (e.g., second RTT threshold value and second PLR threshold value), the WTRU 302 and UPF 308 may determine that this access is congested and may then send the traffic to a low priority access.

In some implementations, in order to enable the steering modes (e.g., active-standby steering mode, smallest delay steering mode, load balancing steering mode, or priority based steering mode) for each of the steering functionalities (e.g., high-layer steering functionality or low-layer steering functionality), rules (e.g., ATSSS rules or N4 rules) may be necessary at both of the WTRU 302 and the UPF 308. These rules (e.g., ATSSS rules or N4 rules) may be generated by the SMF 310, based on information known to the PCF 312. When ATSSS rules are generated by the SMF 310, the ATSSS rules are sent to the WTRU for determining a switching functionality and a switching mode to use for UL traffic. When N4 rules are generated by SMF 310, the N4 rules are sent to the UPF 308 for determining the switching functionality and the switching mode to use for downlink (DL) traffic. In addition, a Performance Measurement Function (PMF) protocol may be used to support at least one of the steering modes at WTRU 302 and UPF 308 to measure parameters (e.g., RTT, Access Availability/Unavailability Reports, PLR) used to determine the switching mode.

Furthermore, a redundant steering mode may be implemented that causes the traffic to be duplicated over both accesses (e.g., 3GPP access 304 and non-3GPP access 306) to meet the requirements of SDFs. There are two types of redundant steering modes, a static type and a dynamic type, based on a dynamicity of the duplication of the traffic. In implementations that use the static redundant steering mode, the network may configure the WTRU 302 and UPF 308 with information as to which access (e.g., one of the 3GPP access 304 and non-3GPP access 306) is a primary access over which all traffic are to be transmitted and which access (e.g., the other one of the 3GPP access 304 and non-3GPP access 306) is a secondary access. In some embodiments, when no primary access is configured, then UPF 308 and WTRU 302 may duplicate packets of the traffic over both accesses (e.g., 3GPP access 304 and non-3GPP access 306) at all times, with (e.g., effectively) a 100% duplication. If the network does configure a primary access, UPF 308 and WTRU 302 may send all traffic over the primary access and determine whether to duplicate traffic over the secondary access. In some implementations, this determination to duplicate traffic over the secondary access may be performed using a non-standardized algorithm or set of instructions or commands. In implementations that use the dynamic redundant steering mode, the duplication determination may be performed for each packet of an SDF, and where the determination is based on measurements of parameters (e.g., RTT, Access Availability/Unavailability Reports, PLR) and evaluation criteria. Dynamic redundant steering mode may (e.g., only) be used for non-GBR SDFs. In addition, in some embodiments, the UPF 308 may determine to suspend or determine to resume traffic duplication. This UPF 308 may determine to suspend or determine to resume traffic duplication based on a traffic load at the UPF 308. When the UPF 308 determines to suspend or to resume traffic duplication the UPF 308 may inform WTRU 302 using a PMF exchange.

### Splitting Traffic Across Two 3GPP Access Legs: Carrier Aggregation, Dual Connectivity, and DualSteer

WTRUs (e.g., WTRU 302) support Carrier Aggregation (CA), which is provided over a single 3GPP access (e.g., 3GPP access 304), i.e., when using New Radio (NR) or Long Term Evolution (LTE), but allows the WTRU (e.g., WTRU 302) to receive over two or more cells. In some implementations, each cell is on a different frequency carrier. The use of the two or more cells may be managed (e.g., entirely) in the Radio Access Networks (RAN). Furthermore, WTRUs (e.g., WTRU 302) also support Dual Connectivity (DC). In some implementations, DC allows a WTRU to receive and/or transmit over two 3GPP accesses or 3GPP access legs (e.g., 3GPP access 304). These 3GPP accesses may be NR (e.g., gNB) or LTE (e.g., eNB). In example 5G systems, DC supports either (a) a first access leg over LTE and a second access leg over NR, or (b) two access legs over NR. In implementations of 5G systems that includes two access legs over NR, the two access legs are on different frequency bands (e.g., a first frequency band and a second frequency band). In order to use DC, a WTRU (e.g., WTRU 302) may require a Radio Frequency (RF) front end to support both access legs. For implementations that use DC, one access leg may be defined as a master leg and part of a Master Cell Group (MCG), and the other access leg may be defined as a secondary leg and part of a Secondary Cell Group (SCG).

WTRUs (e.g., WTRU 302) also support communication over satellite links, allowing a respective WTRU to receive and/or transmit over transparent satellite/repeater links with satellite/repeater in different orbits (e.g., geosynchronous equatorial orbit (GEO), medium earth orbit (MEO), low earth orbit (LEO), high-altitude platform station (HAPS) orbit). In some implementations, a WTRU (e.g., WTRU 302) requires the RF front end to communicate over the transparent satellite/repeater links.

WTRUs (e.g., WTRU 302) may support various combinations of DC and CA. For example, a WTRU (e.g., WTRU 302) may have DC over two 3GPP access legs (e.g., 3GPP access 304), and each of these 3GPP access legs may use CA. A set of cells on one access leg may be referred to as a cell group. Furthermore, a WTRU (e.g., WTRU 302) may have DC with one access leg or both access legs over transparent satellite/repeater links. For example, the following system implementations are supported: (1) a first access leg over NR and a second access leg over GEO satellite, (2) a first access leg over NR and a second access leg over LEO or MEO satellite, or (3) a first access leg over GEO satellite and a second leg over LEO or MEO satellite.

In some implementations, WTRUs (e.g., WTRU 302) with DC may (e.g., already) allow operation over two 3GPP access legs (e.g., 3GPP access 304). When using DC, a WTRU (e.g., WTRU 302) may be configured with how a DRB is mapped over the two access legs. A DRB may be any one of (a) an MCG bearer, such that traffic from the DRB goes over the master access leg, (b) an SCG bearer, such that traffic from the DRB goes over the secondary access leg, or (c) a split bearer, such that traffic from DRB is split between the master access leg and the secondary access leg. When using a split bearer, all processing above a Radio Link Control (RLC) layer is performed in master access leg and all processing below a Packet Data Convergence Protocol (PDCP) layer is performed in one of the master access leg or in secondary access leg.

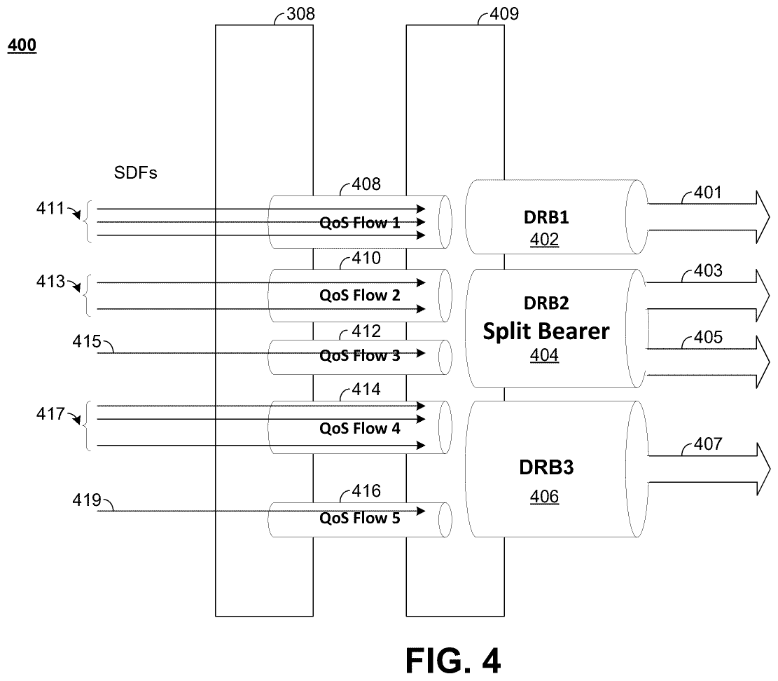

FIG. 4 illustrates how example DL SDFs travel over 5G network 400 and are transmitted over one or more DRBs (e.g., first DRB 402, second DRB 404, and third DRB 406). As illustrated in FIG. 4, each SDF (e.g., first SDF 411, second SDF 413, third SDF 415, fourth SDF 417, and fifth SDF 419) may be mapped, by UPF 308, to a corresponding QoS Flow (e.g., first QoS flow 408, second QoS flow 410, third QoS flow 412, fourth QoS flow 414, and fifth QoS flow 416). The traffic transmitted over these QoS flows (e.g., first QoS flow 408, second QoS flow 410, third QoS flow 412, fourth QoS flow 414, and fifth QoS flow 416) may then arrive at RAN nodes 409, at which each QoS flow is mapped to a DRB (e.g., first DRB 402, second DRB 404, and third DRB 406), and transmitted over a radio interface. Therefore a respective SDF (e.g., first SDF 411, second SDF 413, third SDF 415, fourth SDF 417, and fifth SDF 419) is mapped to a single QoS flow (e.g., first QoS flow 408, second QoS flow 410, third QoS flow 412, fourth QoS flow 414, and fifth QoS flow 416) and each QoS flow is mapped to a single DRB (e.g., first DRB 402, second DRB 404, and third DRB 406). Each respective DRB (e.g., first DRB 402, second DRB 404, and third DRB 406) is configured to transmit traffic over a single access leg, and/or split across two access legs. As illustrated in 5G network 400, first DRB 402 is configured to transmit traffic 401 over a first access leg, third DRB 406 is configured to transmit traffic 407 over a second access leg, and second DRB 404 is configured to transmit traffic 403 over the first access leg, transmit traffic 405 over the second access leg, and/or split traffic (e.g., 403 and 405) between the first access leg and second access leg. As a result, each SDF (e.g., first SDF 411, second SDF 413, third SDF 415, fourth SDF 417, and fifth SDF 419) may rely on DC, and may be transmitted over different 3GPP accesses. However, a single SDF (e.g., first SDF 411, second SDF 413, third SDF 415, fourth SDF 417, and fifth SDF 419) in a DRB (e.g., first DRB 402, second DRB 404, and third DRB 406) may not be split/switched/steered/duplicated over two different 3GPP accesses (e.g., first leg access and second leg access).

In some implementations, the PDCP layer determines an access leg (e.g., mostly) based on an estimated data volume, or an amount of data to be transmitted by the WTRU (e.g., WTRU 302). This determination may be performed for all traffic in each of the DRBs (e.g., first DRB 402, second DRB 404, and third DRB 406). As a result, there may be no mechanism to control the determination of an access leg at a granularity of an SDF (e.g., first SDF 411, second SDF 413, third SDF 415, fourth SDF 417, and fifth SDF 419) and there may be no mechanism to use different metrics for this determination.

Traffic steering and/or switching that is allowed to occur between two 3GPP access networks connected to a same mobile network or different mobile networks may be referred to as DualSteer steering/switching. In some embodiments, the 3GPP access networks are any one of (1) the same Radio Access Technology (RAT), (2) different RATs, (3) terrestrial NR and NR, (4) NR and E-UTRA, (5) a mix of terrestrial and non-terrestrial NR, or (6) dual non-terrestrial NR access. Similarly, the mobile networks may be the same Home Public Land Mobile Network (HPLMN), the same Visited PLMN (VPLMN), different PLMNs, or a PLMN and a PNI-NPN (Public Network Integrated Non-Public Network). In such DualSteer steering/switching implementations, a subscriber of the DualSteer device may have two subscriptions or Subscription Permanent Identifiers (SUPIs), each SUPI sharing one subscription profile from the same operator.

The DualSteer steering and switching functionality is (e.g., only) allowed for DualSteer capable devices. Two example types of DualSteer capable devices (e.g., a WTRU device) include (1) a single UE device that may be used for non-simultaneous data transmission over the two networks and (2) a device with two separate UEs that may be used for simultaneous data transmission over the two networks. The single UE device does not support simultaneous data transmission over two access legs. Hereinafter, the single UE device may also be referred to as a Single UE DualSteer Device (SUEDD), and the device with two separate UEs may also be referred to as a Dual UE DualSteer Device (DUEDD). In addition, for any particular service, at any given time, the DualSteer device may transmit all traffic of that service using (e.g., only) a single 3GPP access network. For DualSteer devices, a number of steering modes (e.g. active-standby, smallest delay, priority based, and load balancing) may be used for steering or switching traffic of a corresponding SDF over one 3GPP access leg (e.g., a first 3GPP access leg) or over another 3GPP access leg (e.g., a second 3GPP access leg). In certain representative embodiments, for purposes of DualSteer, a DualSteer device may include two UEs in which each UE includes at least a respective mobile termination (MT) and a respective Universal Subscriber Identity Module (USIM).

### Evaluation Criteria for Steering Mode Decisions for ATSSS and DualSteer

For each of ATSSS and DualSteer, the WTRU determines whether to steer/switch UL traffic of a corresponding first SDF over an access leg or to split/duplicate UL traffic of a corresponding second SDF over both access legs based on a set of evaluation criteria. Similarly, for both ATSSS and DualSteer, the UPF determines whether to steer/switch DL traffic of a corresponding third SDF over an access leg or to split/duplicate DL traffic of a corresponding fourth SDF over both access legs based on a set of evaluation criteria.

A first set of evaluation criteria may be based on one or more properties of the access legs. For example, the first set of evaluation criteria for a respective access leg includes one or more of (1) an availability of the respective access leg, (2) delay of the respective access leg, (3) congestion over the respective access leg, (4) load over the respective access leg, or (5) priority of the respective access leg.

A second set of evaluation criteria may be based on one or more properties of the device (e.g., WTRU). For example, the second set of evaluation criteria for a respective device includes one or more of (1) a location of the respective device, (2) a power of the respective device, (3) a UL transmission mode of the respective device, or (4) a DL transmission mode of the respective device.

A third set of evaluation criteria may be based on meeting a load balancing requirement at one or both of the device (e.g., WTRU 302) or UPF 308. In some embodiments, a device may determine to split UL traffic over a first access leg and a second access leg based on a percentage split. For example, one of the device (e.g., WTRU 302) or UPF 308 determines to split 40% of traffic over a first access leg and 60% of the traffic over a second access leg.

### Decision Times for Evaluating Steering Modes for ATSSS and DualSteer

In some implementations, each of the WTRU 302 and UPF 308 may evaluate the criteria to steer/switch/split/duplicate traffic, at specific time instances. For steering, the evaluation time may occur at the start of the traffic flow (e.g., SDF). For switching, splitting, and/or duplication, the evaluation time may occur when a condition of an access leg changes. For example, the condition of an access leg may be based on (a) an availability or unavailability of the access leg, (b) an RTT PMF measurement exceeding a first RTT threshold, (c) an RTT PMF measurement falling below a second RTT threshold, (d) a PLR PMF measurement exceeding a first PLR threshold, and/or (e) a PLR PMF measurement falling below a second PLR threshold. In some embodiments, the first RTT threshold may be the same as the second RTT threshold, and the first PLR threshold may be the same as the second PLR threshold. Additionally, the evaluation time may be determined based on a transmission of a PDU for a traffic flow (e.g., either UL traffic flow at the WTRU or DL traffic flow at the UPF).

Conditions to steer/switch/split/duplicate for DualSteer devices may be dependent on a number of factors. In some embodiments, the conditions for ATSSS may not be sufficient to enable the steering/switching/splitting/duplication determinations. For example some conditions for one of DualSteer and ATSSS are based on a type of connection, or on a quality of QoS provided over the access leg. In some embodiments, the evaluation times for determining whether to steer/switch/split/duplicate may not be based (e.g., only) on measurements and transmission opportunities. For example, evaluation times for determining whether to steer/switch/split/duplicate may be triggered by device mobility.

As discussed herein, enhanced steering modes may enable the system to take full advantage of the two 3GPP access legs and to support the use cases for DualSteer devices. The present disclosure provides steering modes that may include one or more of (1) evaluation criteria to determine whether to steer/switch/split/duplicate traffic based on properties of the device (e.g., WTRU), (2) evaluation criteria to determine whether to steer/switch/split/duplicate traffic based on properties of each access leg, (3) evaluation criteria to determine to steer/switch/split/duplicate traffic based on user preferences, (4) evaluation times to evaluate the criteria and determine whether to steer/switch/split/duplicate traffic, (5) methods to evaluate the criteria at the evaluation times, and (6) support from the RAN node and/or mobile network to assist in the evaluation of the criteria.

Hereinafter, the term “access leg RAT” may be used to refer to the RAT of the access leg. In some embodiments, various access leg RATs are considered such as NR, LTE, non-3GPP, terrestrial, GEO satellite, MEO satellite, LEO satellite, HAPS, direct, via Relay WTRU, via multi-hop relay WTRUs. The term “mobile network type” may be used to refer to mobile network type of the access leg. In some embodiments, various mobile network types are considered such as a HPLMN, Equivalent HPLMN (eHPLMN), VPLMN, PNI-NPN, and SNPN. Hereinafter, the term “evaluation time” may be used to refer to an instance in time when a device (e.g., WTRU) and/or UPF evaluates whether to steer/switch/split/duplicate traffic of a corresponding SDF. The term “evaluation criteria” may be used to refer to criteria used to make a determination to steer/switch/split/duplicate traffic of a corresponding SDF. Hereinafter, the term “evaluation decision” may be used to refer to a mechanism used by the WTRU and/or UPF to determine whether to steer/switch/split/duplicate traffic of a corresponding SDF. Evaluation decisions may be made at the evaluation times, and the evaluation decisions may be based on the evaluation criteria. In the following, the term “mobility event” may be used to refer to cell selections, cell reselections, and/or handovers for a WTRU. Hereinafter, the term “provided QoS level” or “QoS level provided” may be used, interchangeably, to refer to a QoS provided by an access leg. The QoS level may be measured in terms of some quantitative measure such as delay, loss, or bit rate, or in terms of some qualitative measure such as whether GBR is no longer met for QoS flow. In the following, actions discussed herein are described as being performed by the device or WTRU. It may be understood that these discussed actions are for UL transmissions and that an equivalent set of actions may be performed at the UPF for DL transmissions.

### Setting Up New/Enhanced Steering Modes

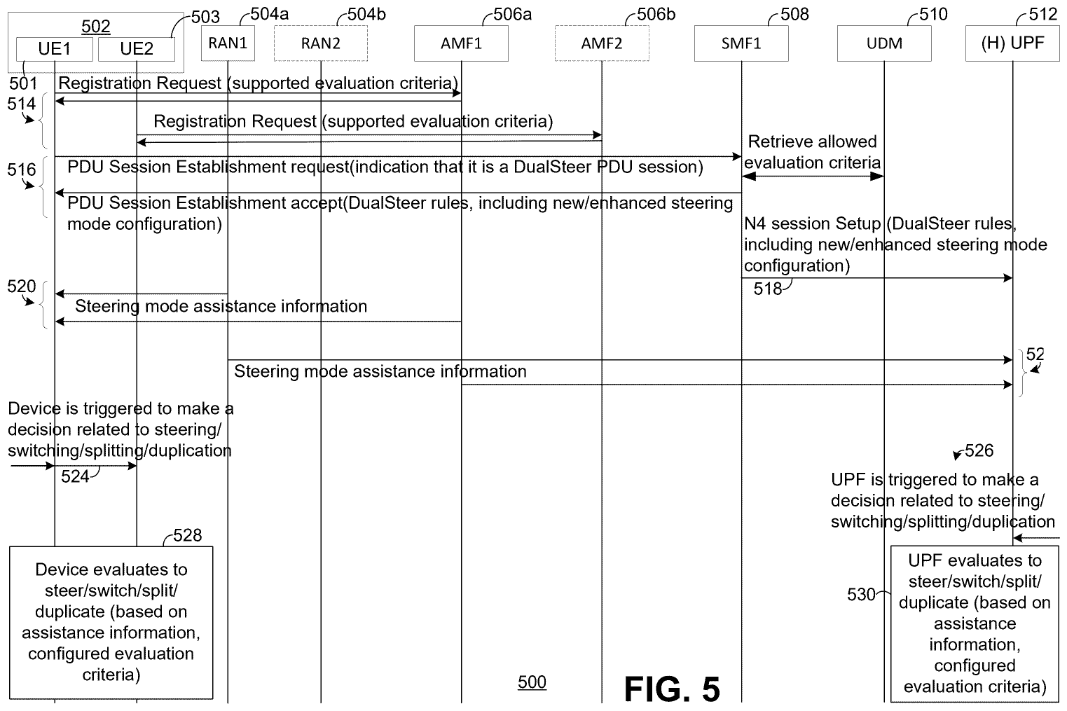

FIG. 5 is a procedure 500 to setup a PDU session using new steering modes on a wireless network that may be established implemented on the communications system illustrated in FIG. 1A.

At step 514, the device 502 (e.g., WTRU) registers to both mobile networks (e.g., a first mobile network and a second mobile network) of the wireless network using a first UE 501 and a second UE 503 included within the device 502 (e.g., WTRU). First UE 501 registers to the first mobile network (e.g., via a first AMF 506a) and the second UE 503 registers to the second mobile network (e.g., via a second AMF 506b). In some embodiments, the first mobile network and the second mobile network may be the same mobile network, or different mobile networks. As a part of UE registration, the device 502 (e.g., WTRU) may share a list of steering/switching/splitting/duplication mode evaluation criteria that are supported, wherein the evaluation criteria are transmitted in one or more of a registration request transmitted from the device 502 (e.g., WTRU).

At step 516, the device 502 (e.g., WTRU) establishes a PDU session (e.g., a DualSteer PDU session). In some embodiments, device 502 (e.g., WTRU) transmits a PDU establishment request that includes an indication that the PDU session is a DualSteer PDU session. A DualSteer PDU session may include two single access PDU sessions that are linked to the same device (e.g., device 502), where each SA PDU session uses one of the access legs (e.g., a 3GPP access leg or a non-3GPP access leg). The DualSteer PDU session allows traffic of an SDF to be steered or switched over one of the two SA PDU sessions. The DualSteer PDU session also allows traffic of an SDF to be split or duplicated across both SA PDU sessions. After transmitting the PDU session establishment request, device 502 (e.g., WTRU) then receives a PDU session establishment acceptance, which may include DualSteer rules such as a steering mode configuration. This steering mode configuration may include one or more evaluation criteria. The wireless network may use subscription information to determine the evaluation criteria that are allowed by device 502 (e.g., WTRU) and may configure the evaluation criteria based on the (1) subscription information retrieved from UDM 510 and (2) the supported evaluation criteria of the wireless network (e.g., supported evaluation criteria of step 514). Although FIG. 5 shows an exchange of PDU session establishment messages (e.g., a PDU session establishment request and a PDU session establishment response/acceptance) for first UE 501 of device 502 (e.g., WTRU), a similar exchange may be performed for second UE 503. In such a case, the second UE 503 exchanges PDU session establishment messages with second AMF 506b). In some implementations, this exchange of PDU session establishment messages uses SMF 508 or a second SMF (not shown in FIG. 5).

At step 518, the UPF 512 receives the steering mode configuration. This configuration may include one or more evaluation criteria disclosed herein. In some embodiments, UPF 512 receives an N4 session setup message which includes the steering mode configuration and DualSteer rules.

At step 520, the device 502 (e.g., WTRU) receives information from first RAN node 504a and/or first mobile network (e.g., first AMF 506a) in order to perform a determination, at the WTRU, on whether to steer/switch/split/duplicate traffic of one or more SDF. In some implementations, the device 502 may also receive information from second RAN node 504b and/or second mobile network (e.g., second AMF 506b) in order to perform the determination, at the WTRU, on whether to steer/switch/split/duplicate traffic of one or more SDF. The information received by the device 502, from the second RAN node 504b and the second mobile network (e.g., second AMF 506b), are not shown in FIG. 5.

At step 522, UPF 512 receives information from first RAN node 504a and/or first mobile network (e.g., first AMF 506a) in order to perform a determination, at the UPF 512, on whether to steer/switch/split/duplicate traffic of one or more SDF. In some implementations, UPF 512 may also receive information from second RAN node 504b and/or second mobile network (e.g., second AMF 506b) in order to perform the determination, at the UPF 512, on whether to steer/switch/split/duplicate traffic of one or more SDF. The information received by the UPF 512, from the second RAN node 504b and the second mobile network (e.g., second AMF 506b), are not shown in FIG. 5.

At step 524, device 502 (e.g., WTRU) receives a triggering event, which indicates to the WTRU to perform a determination to steer/switch/split/duplicate traffic.

At step 526, UPF 512 receives a triggering event, which indicates to the UPF to perform a determination to steer/switch/split/duplicate traffic.

At step 528, device 502 (e.g., WTRU) evaluates whether to steer/switch/split/duplicate traffic of an SDF. Device 502 may evaluate to steer/switch/split/duplicate traffic of an SDF based on the steering information and the steering mode configuration.

At step 530, UPF 512 evaluates whether to steer/switch/split/duplicate traffic of an SDF. UPF 512 may evaluate to steer/switch/split/duplicate traffic of an SDF based on the steering information and the steering mode configuration.

### New Evaluation Criteria to Steer/Switch/Split/Duplicate Traffic

### New Evaluation Criteria Based on Properties of the Device

The evaluation criteria to steer/switch/split/duplicate traffic may be based on one or more of the following properties of a device 502 (e.g., WTRU): (1) a speed of the device 502 (e.g., WTRU), (2) a number of cell reselections or handovers for a UE (e.g., one of the first UE 501 and second UE 503) of the device 502 (e.g., WTRU), (3) a dual UE capability of the device 502 (e.g., WTRU), or (4) a class of the device 502 (e.g., WTRU).

The determination to steer/switch/split/duplicate traffic to a first access leg or second access leg may be based on the speed of the device 502 (e.g., WTRU). For example, a fast moving device 502 may determine to not steer traffic of an SDF over a first access leg which has a smaller coverage (e.g., coverage from a relay UE) than a second access leg. In some implementations, device 502 may be configured with a speed threshold. In such implementations, when the device speed is determined to be above the speed threshold, the traffic may be steered or switched over a first access leg. In alternative embodiments of device 502 configured with the speed threshold, when the device speed is determined to be above the threshold, the traffic splitting or traffic duplication may be suspended by the device 502 (e.g., WTRU). In some embodiments, when the device speed is determined to be below the speed threshold, the traffic may be steered or switched over either access leg (e.g., first access leg or second access leg). In alternative embodiments, when the device speed is determined to be below the speed threshold, the traffic splitting or traffic duplication may be restarted or activated by the device 502 (e.g., WTRU). Furthermore, device 502 (e.g., WTRU) may use Global Positioning System (GPS) capability to determine the device speed. Alternatively, the device 502 (e.g., WTRU) may use a number of cell reselections and/or number of handovers to determine the device speed. When using the device speed as an evaluation criteria, the determined device speed may be compared to a speed threshold value or to a range of device speeds (e.g. a first range of slow device speeds, a second range of fast device speeds)

The determination to steer/switch/split/duplicate traffic to a first access leg or second access leg may be based on a number of mobility events (e.g., cell reselections or handovers) that occur on each access leg (e.g., first access leg and second access leg). For example, if the first UE 501 undergoes many mobility events over a first access leg, this may impact service continuity of device 502. As a result, device 502 (e.g., WTRU) may then determine to not steer or switch traffic to the first access leg. In some implementations, device 502 (e.g., WTRU) may be configured with a time period over which to monitor a number of mobility events (e.g., cell reselections or handovers) over each access leg.

The determination to steer/switch/split/duplicate traffic to a first access leg or second access leg may be based on the Dual UE capability of device 502 (e.g., WTRU). A device (e.g., device 502) may include a single UE and therefore does not allow simultaneous transmissions over both of the first access leg and the second access leg, or the device (e.g., device 502) may be a dual UE device and therefore allows simultaneous transmissions over both access legs. In some implementations, when a device 502 is Dual UE capable, device 502 may determine to steer or switch traffic over any access leg and may determine to split or duplicate the traffic across both access legs. In some implementations, when device 502 is single UE capable, device 502 may determine to steer or switch traffic (e.g., only) over one access leg (e.g., a first access leg or a second access leg). This determination of the one access leg may be based on additional conditions or evaluation criteria. Similarly, if device 502 is single UE capable, device 502 (e.g., WTRU) may determine to suspend the traffic splitting or traffic duplication over the determined access leg.

The determination to steer/switch/split/duplicate traffic to a first access leg or second access leg may be based on a class of the device 502 (e.g., WTRU). The class of device 502 may define a maximum transmit power of device 502 and may limit whether a device 502 uses one or more access legs. This evaluation criteria based on a class of device 502 may be used in combination with other evaluation criteria. For example, device 502 may determine to not steer or switch traffic to a first access leg when the device 502 determines that the class of the device 502 limits the transmit power over the first access leg. As an alternative example, device 502 may determine to suspend traffic splitting or traffic duplication over an access leg over a non-terrestrial network based on a respective class of the device 502 that limits the device from using access legs over any non-terrestrial network.

### New Evaluation Criteria Based on Properties of an Access Leg

The evaluation criteria to steer/switch/split/duplicate traffic may be based on one or more of the following properties of an access leg: (1) an access leg RAT, (2) a type of mobile network (e.g., PLMN, NPN, SNPN, PNI-NPN), (3) a coverage of the access leg, (4) a financial cost of using the access leg, (5) an energy cost of using the access leg of the wireless network, (6) a CN connectivity over the access leg, (7) a QoS of the access leg, (8) a priority of at least one network slice of the wireless network, or (9) an access leg Mobile Network Operator (MNO).

A device (e.g., device 502) may be configured with a preferred access leg RAT or list of preferred access leg RATs. In some implementations the list of preferred access leg RATs may be a prioritized list. In some embodiments, each entry (e.g., access leg RAT) in the list may be associated to a priority number. In some embodiments, multiple access leg RATs may be associated with the same respective priority number, indicating that either access leg RAT of the same priority number may be used for traffic switching and/or steering. The list of preferred access leg RATs may additionally contain a wildcard access leg RAT that is used by the device 502 when no other access leg RAT matches the evaluation criteria. Each respective entry (e.g., respective access leg RAT) in the list may have an indication of respective air interface delay for the respective access leg RAT. For example this indication of respective air interface delay may be (1) an indication of whether the air interface delay is within a range of air interface delay (e.g., low delay, medium delay, high delay), (2) an indication whether the air interface is terrestrial, a GEO satellite, an MEO satellite, a LEO satellite, or a HAPS, or (3) an indication whether the air interface is direct, over a single relay UE, or multi-hop relay UEs.

The device 502 (e.g., WTRU) may be connected via one or more access leg RATs. The device 502 may determine where to steer or switch traffic based on the prioritized list of preferred access leg RATs, such that the device 502 selects the access leg RAT with the highest priority. In some embodiments, if two access legs have the same priority, the device 502 may determine which of the two access legs to select based on other conditions. The device 502 may have rules to determine whether traffic splitting and/or traffic duplication across both access legs is enabled or suspended. For example, according to a rule, the device 502 may decide to enable traffic splitting or traffic duplication if the two access legs have the same priority. As an alternative rule, the device 502 may decide to enable traffic splitting or traffic duplication if the two access legs have similar priorities (e.g., within a same priority range or separated by a preset number entries on the list). For example, if the priority numbers of the two access legs differ by at most K entries of the list, then the device 502 may enable traffic splitting or traffic duplication. According to some rules, the device 502 may determine to suspend traffic splitting and/or traffic duplication if one of the access legs is a wildcard access leg RAT. According to alternative rules, the device 502 may determine to suspend traffic splitting and/or traffic duplication if both access legs have (e.g., very) different air interface delays (i.e., one access leg is terrestrial and the other access leg is non-terrestrial).

A device (e.g., device 502) may be configured with a preferred mobile network type or list of mobile network types. In some implementations, the list of mobile network types may be a prioritized list of mobile network types. In some implementations, each respective entry in the list of mobile network types may be associated with a respective priority number. In some implementations, multiple mobile network types may be associated with a same priority number, indicating that any one of the multiple mobile network types may be used for traffic switching and/or traffic steering. The list of mobile network types may also include a wildcard mobile network type that may be used by the device 502 when no other mobile network type matches conditions and/or evaluation criteria.

The device 502 may be connected via one or more mobile network types. The device 502 may determine where to steer or switch traffic based on a prioritized list of preferred mobile network types, such that the device 502 selects a mobile network type with the highest priority. In some embodiments, if the two access legs are over mobile network types that have a same priority, device 502 may determine which access leg to select based on other conditions. The device 502 may have rules to determine whether traffic splitting and/or traffic duplication across both access legs is enabled or suspended. As a first rule, if the two access legs are over mobile network types with the same priority, the device 502 may determine to enable traffic splitting and/or traffic duplication. As a second rule, if one of the access legs is over a wildcard mobile network type the device 502 may determine to suspend traffic splitting and/or traffic duplication. According to a third rule, if one of the two access legs is over an SNPN mobile network and the other access leg is over a PLMN, the device 502 may determine to suspend traffic splitting and/or traffic duplication.

The device 502 may be configured with an indication of minimum coverage provided by a respective access leg. The coverage of the respective access leg may be specified in terms of (1) a minimum quantitative cell size (e.g., in meters or kilometers) or (2) a qualitative measure of cell size, using one or more size ranges (e.g., small, medium, large). Alternatively, the coverage may be specified in terms of some qualitative measure such as a limited coverage or a dense coverage. In some implementations, the device 502 may determine the coverage based on a connectivity of the device 502 over the respective access leg. For example, a first UE (e.g., first UE 501) connected to a first access leg over a relay UE may have a small coverage. As another example, a second UE (e.g., second UE 503) connected to a second access leg over a HAPS may have limited coverage.

The device 502 may be connected to a wireless network via one or more access legs. In some embodiments, the device 502 may determine where to steer or switch traffic based on the coverage of each respective access leg. For example, some respective traffic may be (e.g., extremely) sensitive to service discontinuity, and therefore the device 502 may determine to not steer, switch, or split this respective traffic to access legs with small coverage. As another example, the device 502 may determine to steer, switch, split, or duplicate traffic to an access leg that is in a mobile network with dense coverage.

Device 502 may be made aware of a financial cost of using a respective access leg, which may be provided in terms of a cost per bit rate (e.g., $/bps) or a cost over time (e.g., $/time period). In some embodiments, the device 502 may determine where to steer or switch traffic based on the associated financial cost of using each access leg. For example, a respective access leg may be over a VPLMN which may result in charges to the user, such as roaming charges. Additionally, the device 502 may determine whether to enable traffic splitting or traffic duplication based on the financial cost associated with an access leg.

Device 502 may be made aware of an energy cost of using a respective access leg, which may be in terms of a consumption rate or an amount of consumption over a time period. In some embodiments, the device 502 may determine where to steer or switch traffic based on the energy cost associated with each access leg. Additionally, the device 502 may determine whether to enable traffic splitting or traffic duplication based on the energy cost associated with an access leg.

A device (e.g., device 502) may be made aware of a CN connectivity through an access leg, for example, whether the traffic is through (1) a visited mobile network (e.g., device 502 is roaming), (2) a home mobile network, (3) an eHPLMN, (4) a visited mobile network with home routing, or (5) a visited mobile network with local breakout. The device 502 may determine where to steer or switch traffic based on the CN connectivity over a respective access leg. For example, when an access leg is through a home network or through a visited mobile network with local breakout, some traffic may (e.g., only) be steered or switched to this access leg for latency reasons. As another example, the device 502 may determine to enable traffic splitting and/or traffic duplication (e.g., only) if the CN connectivity allows each access leg to terminate at a same PDU session anchor UPF (e.g., UPF 512) in order to enable traffic duplication removal and/or traffic recombining.

Each access leg may provide a certain level of QoS that may (e.g., dynamically) change. For example, a RAN node (e.g., first RAN node 504a or second RAN node 504b) may become congested and therefore fail to meet GBR requirements of a QoS flow. For example, a respective QoS level provided by a first access leg changes, the device 502 may determine to switch traffic to a second access leg. As another example, if a respective QoS level provided by the first access leg decreases, device 502 may determine to suspend traffic duplication and/or traffic splitting.

Device 502 may be configured with set of network slices, each network slice associated with a respective priority. In some implementations, if the device 502 is not able to access the highest priority network slice, the device 502 may be triggered to evaluate one or more evaluation criteria and steer or switch traffic to another access leg. In some implementations, a device 502 may be configured with a preferred set of network slices, such as in the form of a prioritized list of preferred network slices. In such a prioritized list of network slice, each network slice may be associated with a respective priority number. In some embodiments, multiple network slices may be associated with the same priority number, indicating that either network slice of the same priority number may be used for traffic switching and/or traffic steering. In some embodiments, the list of network slices may additionally contain a wildcard network slice that may be used by the device 502 when no other network slices are selected. Each respective network slice in the list of preferred network slices may also be associated with an indication of whether the respective network slice allows traffic steering/switching/splitting/duplication. For example, a network slice that is reserved for IoT devices may be configured such that it is not allowed to be used for traffic switching.

The device 502 may be connected via one or more network slices. In some embodiments, the device 502 may determine where to steer or switch traffic based on the prioritized list of preferred network slices, such that the device 502 selects the network slice with the highest priority. If the two access legs are over network slices that have the same priority, the device 502 may select a network slice based on other conditions or evaluation criteria. In some implementations, the device 502 may have rules to determine whether traffic splitting and/or traffic duplication across both access legs is enabled or suspended. According to a first rule, if the two access legs are over network slices with a same priority, the device 502 may determine to enable traffic splitting and/or traffic duplication. According to a second rule, if one of the access legs is over the wildcard network slice, the device 502 may determine to suspend traffic splitting and/or traffic duplication.

The device 502 may determine where to steer or switch traffic and whether to enable or suspend traffic splitting and/or traffic duplication, based on one or more properties of the PLMN or operator of the mobile network (e.g., MNO). One example of this evaluation criteria may be used to evaluate an affinity of the mobile network with an application (e.g., there is a partnership between an application provider and certain MNOs). This evaluation criteria may also be used to evaluate an associated privacy provided by the MNO. For example, an MNO may be more trusted than another MNO, by a user, to keep the user's data private. Furthermore, the evaluation criteria may be used to evaluate a trust toward a respective MNO. For example, an application provider may trust some MNOs more than others for one or more security reasons.

A device (e.g., device 502) may be configured with a preferred PLMN or MNO, or list of preferred PLMNs or MNOs. In some implementations, the list of preferred PLMNs or MNOs may be a prioritized list, where each entry in the list of preferred PLMNs or MNOs may be associated with a respective priority number. Multiple PLMNs or MNOs included in the prioritized list of preferred PLMNs or MNOs may be associated with a same priority number, indicating that any one PLMN or MNO of this same priority number may be used for traffic switching and/or traffic steering. In some implementations, the list of preferred PLMNs or MNOs may include a wildcard PLMN or MNO that may be used by the device 502 when no other PLMN or MNO matches the evaluation criteria. In some implementations, each entry (e.g., each respective PLMN or MNO) in the list of preferred PLMNs or MNOs may include one or more indications of affinity, privacy, or trust associated with each respective PLMN or MNO.

The device 502 may be connected via one or more access leg PLMNs or MNOs. The device 502 may determine where to steer or switch traffic based on the prioritized list of preferred PLMNs or MNOs, such that the device 502 selects a PLMN or MNO with the highest priority. In some embodiments, if the two access leg PLMNs or MNOs have the same priority, the device 502 may determine which access leg PLMN or MNO to select based on other conditions or evaluation criteria. Furthermore, the device may be configured with rules to determine whether traffic splitting and/or traffic duplication across both access legs is enabled or suspended. According to a first rule, if the two access legs have the same priority based on one or more of affinity, security, or trust, the device 504 may determine to enable traffic splitting/duplication. According to a second rule, if the two access legs have similar priority (e.g., within a range of priorities or separated by a preset number of priorities) based on one or more of affinity, security, or trust, the device 502 may determine to enable traffic splitting/duplication.

### New Evaluation Criteria Based on User Preference

In addition to load balancing, the device 502 may determine to steer/switch/split/duplicate traffic based on an indication from a user (e.g., user preference). For traffic steering, when the traffic flow (e.g., of an SDF) begins, the user may be provided with a list of access legs from which the user may determine an access leg for the device 502 to use.

For traffic switching, the device 502 may provide an indication to the user at one or more evaluation times. At these evaluation times the user may be provided with information about the traffic flows, such as an identity of the traffic flow, the current access leg of the traffic flow, whether the traffic flow has splitting enabled or suspended, or whether the traffic flow has duplication enabled or suspended. The user may also be provided with a list of available access legs from which the user may then, for each respective traffic flow, select whether to switch the current access leg being used for the respective traffic flow.

For traffic splitting and/or traffic duplication, the device 502 may also provide an indication to the user at evaluation times. As similarly discussed for traffic switching, at these evaluation times the user may be provided with information about the traffic flows, such as an identity of the traffic flow, a current access leg of the traffic flow, whether the traffic flow has traffic splitting enabled or suspended, or whether the traffic flow has traffic duplication enabled or suspended. The user may also be provided with a list of available access legs from which the user may then, for each respective traffic flow, select whether to enable or suspend traffic splitting and/or select whether to enable or suspend traffic duplication.

### New Evaluation Times

Evaluation times may refer to the time instances when a device 502 and UPF 512 evaluate the conditions, using evaluation criteria, to determine how to steer, switch, split, or duplicate traffic. In some implementations, for steering, the evaluation time (e.g., only) occurs at a start of the traffic flow. In some implementations, for switching, splitting, and/or duplication, the evaluation time may occur when a condition of the access leg is detected. For example the condition of the access leg may be based on an availability or unavailability of the access leg, a RTT PMF measurement exceeding an RTT threshold, an RTT PMF measurement falling below an RTT threshold, a PLR PMF measurement exceeding a PLR threshold, or a PLR PMF measurement falling below a PLR threshold. Additionally, the evaluation time may be based on a transmission of a PDU for a traffic flow (e.g., either UL traffic flow at the device 502 or DL traffic flow at the UPF 512).

In addition to these evaluation times, the device 502 (e.g., WTRU) and/or UPF 512 may evaluate the conditions to determine how to steer, switch, split, or duplicate traffic at the following time instances: (1) during a handover to a new cell, (2) during cell selection, (3) during cell reselection, (4) during PLMN selection or PLMN reselection, (5) receipt of an indication of a change of RAN node from the network, (6) receipt of an indication of a change of RAN node from the device 502, (7) receipt of an indication from a user, (8) during a change of network slice, (9) in response to an indication, from RAN node, about QoS not being met, or change in QoS, (10) receipt of a notification or data analytics from a network data analytics function NWDAF, (11) in response to a notification by the UE application, or (12) when evaluation criteria changes. At any one of these evaluation times, one or both of the device 502 and the UPF 512 may be triggered to evaluate and determine steer, switch, split, or duplicate traffic decisions.

In some embodiments, an access leg may change when a UE performs a handover to a new cell. When a UE performs a cell selection, the access leg may be to a new cell. Similarly, when a UE undergoes cell reselection, the access leg may be to a new cell. In some embodiments, when a UE changes PLMNs, for example, to connect to a higher priority PLMN, the access leg is to a new mobile network.

In some embodiments, a UPF (e.g., UPF 512) may receive an indication from an SMF (e.g., SMF 508) that a UE of the device 502 has undergone a path switch (e.g., by receiving an N4 Session Modification Request). The UPF 512 may also receive information related to the new RAN node (e.g., first RAN node 504a or second RAN node 504b) based on the path switch, the information related to the RAN node including at least a RAT type and a PLMN ID. In some embodiments, UPF 512 may receive an indication (e.g., using a PMF message) from a respective UE of the device 502 (e.g., WTRU) that the respective UE has undergone a handover, cell selection, or cell reselection to a new RAN node. The UPF 512 may also receive information related to the new RAN node (e.g., first RAN node 504a or second RAN node 504b), the information related to the RAN node including at least a RAT type and a PLMN ID.

In some implementations, the device 502 may have a graphical user interface (GUI) that the user may use to indicate, to one or both of the device 502 and UPF 512, a request to evaluate and determine steer, switch, split, or duplicate traffic decisions. This request may include an indication of the targeted traffic flow among multiple traffic flows, and a type of evaluation (e.g., to evaluate whether to switch, enable or suspend splitting, or enable or suspend duplication). The device may also receive an indication that a respective UE of device 502 will be moved to a new network slice.

In some implementations, the RAN node (e.g., a first RAN node 504a or second RAN node 504b) may send an indication to the device that (a) a QoS level has changed, or (b) that the GBR requirement for a QoS flow is no longer being met. For example, the NWDAF may evaluate network conditions and determine that steering/switching/splitting/duplication traffic decisions should be re-evaluated. The NWDAF may also notify the AMF (e.g., first AMF 506a or second AMF 506b) which may send a NAS message to the device 502, the NAS message indicating that the device 502 should re-evaluate the steering/switching/splitting/duplication traffic decisions. The UPF 512 may also subscribe to event notifications from the NWDAF. For example, the UPF 512 may be notified, by the NWDAF, when a delay is predicted to increase above a certain threshold on any one of the two access legs. In some embodiments, a UE application may request a re-evaluation to determine a more appropriate network. This re-evaluation to determine a more appropriate network may be performed for reasons related to privacy or trust of the network.

In addition, when any evaluation criteria change, one or both of the device 502 or UPF 512 may be triggered to evaluate and determine steer, switch, split, or duplicate traffic decisions. For example, an application may update the evaluation criteria for steering/switching/splitting/duplicating traffic, based on an operation being performed. In some implementations, a respective UE may monitor the evaluation criteria or rules, and re-evaluate whenever the evaluation criteria or rules change.

### Evaluation Decisions to Steer/Switch/Split/Duplicate Traffic

An evaluation decision may refer to an outcome determined at one or both of the device 502 or UPF 512 regarding steering/switching/splitting/duplication. Each evaluation decision may be performed at a respective evaluation time, and each evaluation is based on one or more evaluation criteria.

For embodiments that use evaluation criteria that are based on a comparing one or more values (e.g., measurements) to a threshold, the device 502 and/or UPF 512 may maintain a respective criterion for each access leg (e.g., first evaluation criteria for a first access leg and second evaluation criteria for a second access leg). In some implementations, an evaluation decision may be based on (1) a comparison of the evaluation criteria between the two access legs, for example, steer/switch to the first access leg when the first evaluation criteria is greater than the second evaluation criteria, or suspend traffic splitting/duplication when the first evaluation criteria is less than the second evaluation criteria, (2) a comparison of an evaluation criteria of an access leg with respect to a threshold, for example, steer/switch to the access leg when the evaluation criteria is greater than a first threshold, or suspend splitting/duplication when the evaluation criteria is greater than a second threshold, or (3) a comparison to a threshold and comparison between access legs, i.e., steer/switch to the first access leg when the first evaluation criteria is greater than a threshold and the first evaluation criteria is less than the second evaluation criteria.

The evaluation decision may be based on a weighted combination of evaluation criteria, which may allow for complex logic used for one or both of the device 502 and UPF 512 to determine to steer/switch/split/duplicate traffic decisions. For example, when the second access leg is over an HPLMN and uses non-terrestrial RAT, and a delay of the second access leg is less than a delay of the first access leg, one or both of the device 502 or UPF 512 determines to switch traffic to the second access leg.

As another example, when the first access leg is over one of a HPLMN or a VPLMN with home routing, the second access leg is over HPLMN or VPLMN with home routing, each of the first access leg and the second access leg is using terrestrial RAT, and the delay of the second access leg is greater than a threshold, one or both of the device 502 or UPF 512 determines to enable duplication across both access legs (e.g., first access leg and second access leg).

As a third example, when a cost associated with the second access leg is less than a cost associated with the first access leg and the energy used by the second access leg is less than energy used by the first access leg, one or both of the device 502 or UPF 512 determines to steer traffic to the second access leg.

Device 502 may calculate a respective evaluation rating for each available access leg, and determine to switch traffic when the evaluation rating of a respective access leg becomes higher than the evaluation rating of the active leg. In some implementations, there may be additional considerations or conditions, such as determining whether the evaluation rating of an access leg stays at or above an evaluation rating threshold for a predetermined amount of time (e.g., X seconds). In some embodiments, the UE may provide a list of information elements (IEs) for each available access leg to the UE application, and the UE application may determine which access leg to use.

### Indications to Device to Support DualSteer With New Evaluation Criteria

The device (e.g., WTRU) may require steering mode assistance information from the RAN node, mobile network, or UPF 512, to support some of the evaluation criteria. In some embodiments, the RAN node may provide the steering mode assistance information to the device through broadcast system information, non-broadcast system information, or through dedicated signaling. The RAN node may provide the steering mode assistance information to the UPF 512 by sending the steering mode assistance information over the control plane (e.g., through the AMF) or by sending the steering mode assistance information over the user plane (e.g., in a General Packet Radio Service (GPRS) Tunnelling Protocol-User Data (GTP-U) header that includes the steering mode assistance information to the UPF 512). In some embodiments, the RAN node may include one or more of the following types of steering mode assistance information.

The steering mode assistance information from the RAN node may include an indication whether the RAN node is stationary or non-stationary. A non-stationary RAN node may be a HAPS, LEO satellite, or MEO satellite. The steering mode assistance information may include an indication of a type of connectivity the RAN node provides, such as terrestrial, GEO satellite, HAPS, LEO satellite, MEO satellite, ProSe relay, or multi-hop Prose Relay. The steering mode assistance information may further include a size of cell, which may be in terms of a cell geofence. Alternatively, the size of the cell may be specified in terms of a quantitative cell size (e.g., in meters or kilometers) or in terms some qualitative measure of cell size (e.g., size ranges, such as a range for small cell sizes, a range for medium sizes, a range for large cell sizes). The steering mode assistance information may also include a mobile network type. The RAN node may indicate whether the RAN node is connected to a PLMN, an PNI-NPN, or an SNPN. The steering mode assistance information may also include energy cost at RAN node for using access leg. In some embodiments, the RAN node may provide an energy cost in terms of a rate of energy consumption or amount of energy consumption over a period of time. Alternatively, the RAN node may provide a qualitative indication of using the RAN node, i.e., the energy cost may be determined to be within a range of energy consumption (e.g., a range for low energy consumption, a range for medium energy consumption, or a range of high energy consumption). Steering mode assistance may also include information related to a load on an access leg. In some embodiments, the RAN node may provide a qualitative indication of load (e.g., low load, medium load, or high load) based on one or more ranges for the load on an access leg. Alternatively, the RAN node may provide a quantitative indication of load on an access leg, such that the indication of load on the access leg is presented as a percentage (e.g. RAN node has 30% free capacity). In some implementations, congestion on an access leg may also be provided by the RAN node. A change in QoS level may be provided by a RAN node as a steering mode assistance information (e.g., as an indication of the provided QoS level). This indication of the provided QoS level may be sent periodically or in response to a change in QoS level that is larger than a configured or pre-configured QoS threshold. In some embodiments, the RAN node may also send an indication when the RAN node determines that the GBR requirement is no longer being met for a QoS flow based on a QoS monitoring procedure. The steering mode assistance information may also include an indication of the mobile network coverage. This indication of the mobile network coverage may be a qualitative indication such as: a low coverage or a dense coverage. Alternatively, this indication of the mobile network coverage may be a quantitative indication in terms of a percentage (e.g. 50% of area is covered). In some implementations, the mobile network may provide the steering mode assistance information to the device 302 via pre-configuration (e.g., in a mobile equipment (ME) or a Universal Integrated Circuit Card (UICC)), via NAS signaling (e.g., through policy signaling, SM signaling, or MM signaling), or via user plane signaling (e.g., using IPv6 router advertisement including energy usage, or using explicit congestion notification (ECN)). In some embodiments, the mobile network may provide the steering mode assistance information to the UPF 512 via control plane signaling.

In some implementations, the mobile network may include one or more of the following types of steering mode assistance information: (1) an energy usage or energy cost of using the mobile network, (2) a financial cost of using the mobile network, (3) an indication of the mobile network coverage, or (4) a load over the mobile network. The mobile network may provide an energy usage and/or energy cost in terms of an energy consumption rate or amount of energy consumption over a period of time. Alternatively, the mobile network may provide a qualitative indication of the cost of using the mobile network, i.e., the energy cost may be one of a low energy cost, a medium energy cost, or a high energy cost, based on one or more ranges of energy cost of using access legs. The mobile network may also provide a financial cost of using access legs in terms of a cost rate or financial over a period of time. Alternatively, the mobile network may provide a qualitative indication of the financial cost of using the mobile network, i.e., the financial cost may be one of a low financial cost, a medium financial cost, or a high financial cost based on one or more ranges of financial cost of using access legs. In some embodiments, the mobile network may determine the financial cost for using an access leg based on whether the device is roaming or based on the service level agreements between the mobile network and the home network of the device 502. This steering mode assistance information provided by the mobile network may also include an indication of the mobile network coverage, which may be a qualitative indication such as low coverage or dense coverage, or may be a quantitative indication in terms of a percentage (e.g., 50% of an area is covered). Furthermore, the steering mode assistance information may include a load over the mobile network. This information related to the load over the mobile network may be a qualitative indication such as: low load, medium load, or high load. Alternatively, the load over the mobile network may be a quantitative indication in terms of a percentage (e.g. mobile network has 30% free capacity) or an indication of an amount of ECN congestion markings in the user plane traffic.

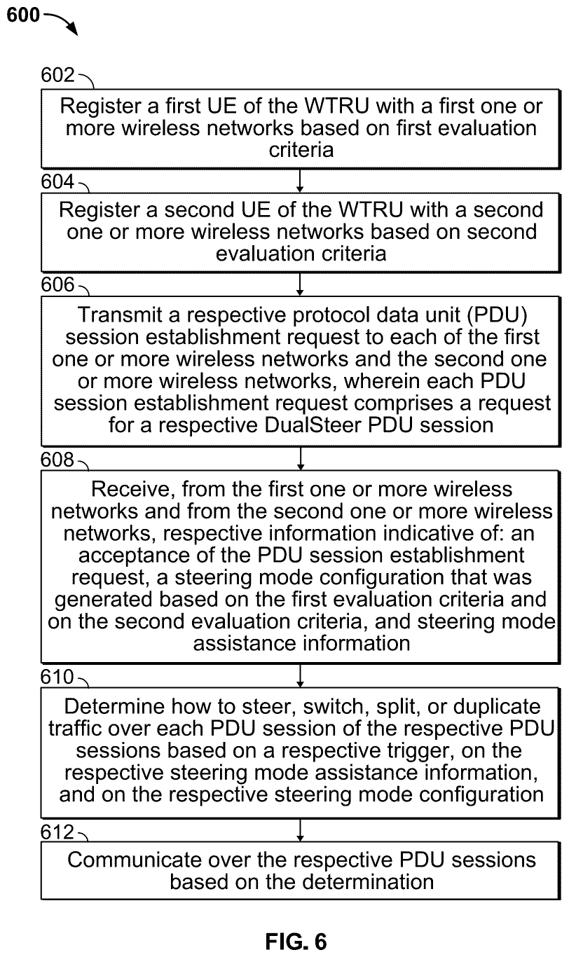

FIG. 6 shows a flowchart of an illustrative process 600 for managing traffic over a PDU session with a wireless network, which may be implemented using the communications system 100 illustrated in FIG. 1A.

At 602, the WTRU registers a first UE of the WTRU with a first one or more wireless networks based on first evaluation criteria. In some implementations, the first UE sends an indication of a type of first evaluation criteria that is supported by the first UE. This indication of the type of first evaluation criteria supported by the first UE may be sent to the first one or more wireless networks as part of a registration message sent from the first UE.

At 604, the WTRU registers a second UE of the WTRU with a second one or more wireless networks based on second evaluation criteria. In some implementations, the second UE sends an indication of a type of second evaluation criteria that is supported by the second UE. This indication of the type of second evaluation criteria supported by the second UE may be sent to the second one or more wireless networks as part of a registration message sent from the second UE. In some implementations, each of the first one or more wireless networks and the second one or more wireless networks include a common subset of wireless networks.

At 606, the WTRU transmits a respective PDU session establishment request to each of the first one or more wireless networks and the second one or more wireless networks, wherein each PDU session establishment request includes a request for a respective DualSteer PDU session.

At 608, the WTRU receives, from the first one or more wireless networks and from the second one or more wireless networks, respective information indicative of (a) an acceptance of the PDU session establishment request (e.g., at 806), (b) a steering mode configuration that was generated based on the first evaluation criteria and on the second evaluation criteria, and (c) steering mode assistance information.

At 610, the WTRU determines how to steer, switch, split, or duplicate traffic over each PDU session of the respective PDU sessions based on a respective trigger, on the respective steering mode assistance information, and on the respective steering mode configuration. The traffic may originate from one or both of the first UE or the second UE. In some implementations, each established PDU session is a DualSteer PDU session.

At 612, the WTRU communicates over the respective PDU sessions based on the determination performed at 610.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a RF transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

What is claimed is:

1. A method, performed by a wireless transmit/receive unit (WTRU) with DualSteer capability, the method comprising:
registering a first user equipment (UE) of the WTRU with a first one or more wireless networks based on first evaluation criteria;
registering a second UE of the WTRU with a second one or more wireless networks based on second evaluation criteria;
transmitting a respective protocol data unit (PDU) session establishment request to each of the first one or more wireless networks and the second one or more wireless networks, wherein each PDU session establishment request comprises a request for a respective DualSteer PDU session;
receiving, from the first one or more wireless networks and from the second one or more wireless networks, respective information indicative of:
an acceptance of the PDU session establishment request,
a steering mode configuration that was generated based on the first evaluation criteria and on the second evaluation criteria, and
steering mode assistance information,
determining how to steer, switch, split, or duplicate traffic over each PDU session of the respective PDU sessions based on a respective trigger, on the respective steering mode assistance information, and on the respective steering mode configuration; and
communicating over the respective PDU sessions based on the determination.

2. The method according to claim 1, wherein the traffic originates from at least one of the first UE or the second UE.

3. The method according to claim 1, wherein receiving respective information indicative of steering mode assistance information comprises receiving steering mode assistance information from at least one of respective mobile networks of the first one or more wireless networks and the second one or more wireless networks or respective radio access network (RAN) nodes of the first one or more wireless networks and the second one or more wireless networks.

4. The method according to claim 1, the method further comprising receiving the respective trigger for a respective wireless network, wherein the respective trigger is any one of a mobility event, an indication from a RAN node, an indication from the respective wireless network, or an indication of coverage of the respective wireless network.

5. The method according to claim 1, wherein each of the first evaluation criteria and the second evaluation criteria comprise any one or more evaluation criteria based on WTRU properties, any one or more evaluation criteria based on wireless network properties, or any one or more evaluation criteria based on user preference.

6. The method according to claim 5, wherein the WTRU properties comprises a speed of the WTRU, a number of mobility events for the WTRU, a dual UE capability of the WTRU, and a class of the WTRU.

7. The method according to claim 5, wherein the wireless network properties comprises access leg radio access technology (RAT) of a respective wireless network, type of mobile network, coverage of the respective wireless network, financial cost of using an access leg of the respective wireless network, energy cost of using an access leg of the respective wireless network, a core network connectivity over at least one access leg of the respective wireless network, quality of service (QoS) of an access leg of the respective wireless network, a priority of at least one network slice of the respective wireless network, and an access leg Mobile Network Operator (MNO) of the respective wireless network.

8. The method according to claim 1, wherein determining how to steer, switch, split, or duplicate traffic over each PDU session of the respective PDU sessions comprises:
comparing first values of first evaluation criteria to second values of second evaluation criteria; and
determining how to steer, switch, split, or duplicate traffic over each PDU session based on the comparison of first values of first evaluation criteria to second values of second evaluation criteria.

9. The method according to claim 1, wherein determining how to steer, switch, split, or duplicate traffic over each PDU session of the respective PDU sessions comprises:
comparing one of: (1) first values of first evaluation criteria or (2) second values of second evaluation criteria, to at least one threshold value; and
determining how to steer, switch, split, or duplicate traffic over each PDU session based on the comparison of one of: (1) first values of first evaluation criteria or (2) second values of second evaluation criteria, to at least one threshold value.

10. The method according to claim 1, wherein each of the first one or more wireless networks and the second one or more wireless networks comprise a common subset of wireless networks.

11. A wireless transmit/receive unit (WTRU) with DualSteer capability, the WTRU comprising:
a first user equipment (UE);
a second UE; and
processing circuitry, wherein the WTRU is to:
register the first UE with a first one or more wireless networks based on first evaluation criteria;
register the second UE with a second one or more wireless networks based on second evaluation criteria;
transmit a respective protocol data unit (PDU) session establishment request to each of the first one or more wireless networks and the second one or more wireless networks, wherein each PDU session establishment request comprises a request for a respective DualSteer PDU session;
receive, from the first one or more wireless networks and from the second one or more wireless networks, respective information indicative of:
an acceptance of the PDU session establishment request,
a steering mode configuration that was generated based on the first evaluation criteria and on the second evaluation criteria, and
steering mode assistance information,
determine how to steer, switch, split, or duplicate traffic over each PDU session of the respective PDU sessions based on a respective trigger, on the respective steering mode assistance information, and on the respective steering mode configuration; and
communicate over the respective PDU sessions based on the determination.

12. The WTRU of claim 11, wherein the traffic originates from at least one of the first UE or the second UE.

13. The WTRU of claim 11, wherein to receive respective information indicative of steering mode assistance information the WTRU is to receive steering mode assistance information from at least one of respective mobile networks of the first one or more wireless networks and the second one or more wireless networks or respective radio access network (RAN) nodes of the first one or more wireless networks and the second one or more wireless networks.

14. The WTRU of claim 11 is further to receive the respective trigger for a respective wireless network, wherein the respective trigger is any one of a mobility event, an indication from a RAN node, an indication from the respective wireless network, or an indication of coverage of the respective wireless network.

15. The WTRU of claim 11, wherein each of the first evaluation criteria and the second evaluation criteria comprise any one or more evaluation criteria based on WTRU properties, any one or more evaluation criteria based on wireless network properties, or any one or more evaluation criteria based on user preference.

16. The WTRU of claim 15, wherein the WTRU properties comprises a speed of the WTRU, a number of mobility events for the WTRU, a dual UE capability of the WTRU, and a class of the WTRU.

17. The WTRU of claim 15, wherein the wireless network properties comprises access leg radio access technology (RAT) of a respective wireless network, type of mobile network, coverage of the respective wireless network, financial cost of using an access leg of the respective wireless network, energy cost of using an access leg of the respective wireless network, a core network connectivity over at least one access leg of the respective wireless network, quality of service (QoS) of an access leg of the respective wireless network, a priority of at least one network slice of the respective wireless network, and an access leg Mobile Network Operator (MNO) of the respective wireless network.

18. The WTRU of claim 11, wherein to determine how to steer, switch, split, or duplicate traffic over each PDU session of the respective PDU sessions, the WTRU is to:
compare first values of first evaluation criteria to second values of second evaluation criteria; and
determine how to steer, switch, split, or duplicate traffic over each PDU session based on the comparison of first values of first evaluation criteria to second values of second evaluation criteria.

19. The WTRU of claim 11, wherein to determine how to steer, switch, split, or duplicate traffic over each PDU session of the respective PDU sessions, the WTRU is to:
compare one of: (1) first values of first evaluation criteria or (2) second values of second evaluation criteria, to at least one threshold value; and
determine how to steer, switch, split, or duplicate traffic over each PDU session based on the comparison of one of: (1) first values of first evaluation criteria or (2) second values of second evaluation criteria, to at least one threshold value.

20. The WTRU of claim 11, wherein each of the first one or more wireless networks and the second one or more wireless networks comprise a common subset of wireless networks.
